(19) United States
(12) Patent Application Publication
(10) Pub. No.: US 2026/0186451 A1
(43) Pub. Date: Jul. 2, 2026

(54) METHOD FOR TRAINING A BRAIN-COMPUTER INTERFACE ON-LINE

(71) Applicant: COMMISSARIAT A L'ÉNERGIE ATOMIQUE ET AUX ENERGIES ALTERNATIVES, Paris (FR)

(72) Inventors: Rémi SOURIAU, Grenoble Cedex 09 (FR); Felix MARTEL, Grenoble Cedex 09 (FR); Tetiana AKSENOVA, Grenoble Cedex 09 (FR)

(73) Assignee: COMMISSARIAT A L'ÉNERGIE ATOMIQUE ET AUX ENERGIES ALTERNATIVES, Paris (FR)

(21) Appl. No.: 19/433,384

(22) Filed: Dec. 26, 2025

(30) Foreign Application Priority Data
Dec. 27, 2024 (FR) FR2415310

(51) Int. Cl. G05B 13/02; G05B 13/04

(52) U.S. Cl. CPC G05B 13/0265; G05B 13/048

(57) ABSTRACT

The invention relates to a method for training a brain-computer interface, the brain-computer interface being connected to sensors (2₁ . . . 2_{I1}) arranged beforehand around the brain of a user, the interface being configured to control an actuator (6) depending on electrophysiological signals detected by each sensor, the training method comprising forming a predictive model (F), by regression between a training tensor formed from the detected electrophysiological signals, and a control tensor representative of mental tasks executed by the user during various time epochs, the predictive model making it possible to predict a task, imagined by the user, depending on the electrophysiological signals detected in each epoch, the method being such that the predictive model is formed depending on the weight assigned to each epoch.

### TECHNICAL FIELD

The technical field of the invention is that of brain-computer interfaces, or BCIs, intended to control an actuator on the basis of neurophysiological signals.

### PRIOR ART

The field of brain-computer interfaces is undergoing rapid development and appears to provide an attractive solution allowing users with disabilities to control actuators with their minds. This involves detecting and recording electrophysiological signals generated by the cortex. These signals are processed by algorithms allowing a control signal to be formed, with a view to controlling actuators. The control signal is used to control the actuator, the latter being an exoskeleton, a computer or a robot, with a view to providing the user with assistance. The algorithms implemented translate an instruction given by the user, this instruction being sensed, by electrodes, in the form of signals that are called electrophysiological signals because they are representative of the electrical activity of neurones. This electrical activity may be measured in the cortex, by means of cortical electrodes arranged in the skull. It may also be measured by electroencephalography electrodes, which are less intrusive because they are arranged on the scalp, but also lower performance, particularly in terms of spatial resolution. Another solution is to record electrophysiological signals by magnetoencephalography, this requiring a dedicated apparatus.

The algorithms implemented are generally based on a predictive model. The predictive model uses input data, which is obtained by pre-processing the recorded electrophysiological signals, to establish a control signal intended for the one or more actuators. The control signal must correspond to an intention expressed by the user whose electrophysiological signals are being recorded. The intention expressed by the user manifests itself in the form of the electrophysiological signals, the latter being recorded and transmitted to the brain-computer interface, forming observation data. The electrophysiological signals are processed to obtain observation data, which form the input data of the predictive model, the latter generating a control signal corresponding to the intention expressed by the user. The control signal allows the actuator to be controlled.

The measured signals are processed to form observation data that are generally multidimensional, and which comprise:
a spatial component, representative of the spatial origin of the electrophysiological signal;
a frequency component, representative of the intensity of the electrophysiological signal in various frequency bands; and
a temporal component.

Each observation data is associated with an epoch, i.e. with a time interval of predetermined duration, for example of about 1 second, after the user first intends to perform the task. In each epoch, an observation tensor collating the observation data is formed. A predictive model is fed with the observation tensor. The predictive model, applied to the observation tensor, allows estimation of a control signal, allowing the actuators to be controlled. The control signal is generally expressed by a control vector.

The predictive model is established during a training phase, during which the user performs predefined tasks, for which the output of the predictive model is known. The objective is then, following each task, to determine components of the recorded electrophysiological signals specific to the task. It may in particular be a question of determining correlations between components of the electrophysiological signals and the output of the model.

Ways in which predictive models may be established have been amply described. For example, the U.S. Pat. No. 9,480,583 describes application of an N-way partial least squares method allowing a predictive model to be established. Such a method is also known by the acronym NPLS. Application of such a method has also been described in the publication Eliseyev A, Aksenova T (2013) “Recursive N-way Partial Least Squares for Brain Computer Interface” PLOS ONE July 2013, Volume 8 Issue 7 e69962. Such a method is also described in the document Yelisyeyev A “Brain-Computer Interface with cortical electrical activity recording. Human health and pathology”. Université de Grenoble, 2011.

However, NPLS methods require a large number of training data to be processed, for example several hundred or several thousand training data for a model output corresponding to one specific task. This requires a large amount of information to be stored in memory, something that is incompatible with on-line training, i.e. training in real time, or near real time. By near real time, what is meant is training performed through successive sequences, each sequence lasting a few seconds or a few minutes.

In order to decrease the amount of information to be stored, a training method implementing a REW-NPLS method was developed, REW standing for Recursive Exponentially Weighted. Formation of a predictive model, by REW-NPLS, applied to a BCI, is described in EP3563218. Such an approach is also justified by the fact that neuronal signals are not immutable, meaning that the predictive model must be regularly updated.

The inventors have discovered an improvement to the method described in EP3563218, allowing the training performance of the predictive model to be improved.

### SUMMARY OF THE INVENTION

A first subject of the invention is a method for training a brain-computer interface, the brain-computer interface being connected to sensors arranged beforehand around the brain of a user, each sensor being configured to detect an electrophysiological signal dependent on a neural activity of the user, the interface being configured to control an actuator based on the detected electrophysiological signals, the training method comprising:
a) selecting a mental task to be performed, chosen from a predetermined list of tasks;
b) the user executing the mental task selected in step a), the training method further comprising, during execution of the task:
   acquiring electronic signals generated by the various sensors;
   extracting features from the electronic signals;
   forming an observation tensor from the features extracted from the signals;
c) repeating steps a) and b) during a predetermined number of time epochs, forming a sequence;
d) forming a training tensor from the observation tensors formed in each time epoch, and a control tensor from the tasks selected in each epoch, each term of the training tensor and of the control tensor being associated with one epoch of the sequence;
e) forming a predictive model, by regression between the training tensor and the control tensor, the predictive model making it possible to predict a task, chosen from the list of tasks, imagined by the user depending on the observation tensor formed in each epoch;
steps b), d) and e) being implemented by a processing unit;
the method being characterized in that it comprises:
defining a weighting criterion for each epoch;
assigning a weight to each epoch, the weight being defined depending on the weighting criterion of said epoch, so that to two different epochs, of the sequence, of which the weighting criterion is different, two different weights are assigned;
the method being such that the predictive model is formed depending on the weight assigned to each epoch.

The term “epoch” corresponds to a time range, of predetermined duration, for example 1 second, during which steps a) and b) are implemented.

The weight assigned to an epoch may depend on the task selected during said epoch.

According to one possibility:
steps a) to e) are implemented during a plurality of successive sequences;
the weighting criterion is a frequency of occurrence of each task, the weight of each epoch increasing as the number of occurrences of the task, in the successive performed sequences, decreases.

According to one possibility, after each new sequence, the method comprises an update of a weighted total number of occurrences for each task, the update comprising, for each task:
determining a number of occurrences in the new sequence;
weighting the number of occurrences, in the new sequence, by the weight assigned to the task in the new sequence;
summing the weighted number of occurrences of the task, in the new sequence, to the weighted total number for said task resulting from the previous sequence, the latter being multiplied by a forgetting factor.

According to one possibility, the weighting criterion is a training-performance criterion, the method comprising:
determining a training-performance indicator for each task following each epoch;
determining the weight of each task based on the training-performance criterion of the task.

According to one possibility, weighting criterion is a signal-quality criterion quantifying the quality of the signals collected in each sequence, the method comprising:
determining a signal-quality criterion for the signals collected in each sequence;
determining the weight of each task depending on the signal-quality criterion of the respective signals collected during the execution of each task.

According to one possibility, in step e), the predictive model is formed by N-way regression, comprising calculation of a cross-covariance tensor expressing the cross-covariance between the training tensor and the control tensor, the cross-covariance tensor of each sequence being established from a product:
of the observation tensor;
of the control tensor;
and of the respective weights assigned to each epoch.

According to one possibility:
step c) is repeated so as to form a plurality of successive sequences, each sequence being assigned a rank;
step d) is implemented for each sequence;
in step e), the predictive model is formed from two successive sequences, on the basis of a sum of the cross-covariance tensor established for the sequence of higher rank and of the cross-covariance tensor established for the sequence of lower rank multiplied by a forgetting factor.

According to one possibility:
the training tensor and the control tensor are formed from a matrix, one dimension of which is the number of epochs in the sequence;
the weights assigned to each epoch of the sequence form a diagonal matrix, each dimension of which is the number of epochs per sequence, each term of the diagonal matrix corresponding to the weight assigned to each epoch executed in said sequence.

According to one possibility, for at least one specific task, the weight is determined such that the number of occurrences of said specific task, weighted by the weight assigned to the specific task, is greater than the number of occurrences of at least one other task, weighted by the weight assigned to said other task.

According to one possibility, the weight assigned to each task is bounded by a predefined maximum value.

Another object of the invention is a brain-computer interface, the brain-computer interface comprising sensors arranged beforehand around the brain of a user, and configured to detect electrophysiological signals representative of neural activity of the user, the interface being programmed to control an actuator, by implementing a predictive control model, the predictive model being configured to generate an actuator control signal from detected electrophysiological signals, the interface comprising a processing unit configured to acquire the electronic signals in each step b), and to implement steps d) and e) of a method according to the first subject of the invention.

The actuator may be a device external to the user or a device implanted in the user's body.

The invention will be better understood on reading the description of examples of embodiment that are presented, in the remainder of the specification, with reference to the figures listed below.

### FIGURES

FIG. 1 schematically shows a brain-computer interface connected to a user, and connected to a processor capable of implementing a method according to the invention.

FIG. 2 shows the main steps of a method for implementing the invention.

FIG. 3 shows a geometric mean of the class recall determined by an off-line predictive model parametrized by NPLS or SW-NPLS as a function of a class imbalance ratio. The y-axis corresponds to the geometric mean and the x-axis corresponds to the class imbalance ratio.

FIG. 4 shows a comparison of the geometric mean of the class recall determined by a predictive model implementing various training algorithms. The y-axis corresponds to the geometric mean and the x-axis corresponds to each training algorithm.

FIGS. 5A to 5C show a variation in class size as a function of a number of iterations in the case of implementation of a predictive model trained by REW-NPLS (corresponding to the prior art), and of implementation of the invention, taking into account a maximum weight per class equal to 2 and 10.

FIGS. 5D to 5F show the class imbalance ratio as a function of a number of iterations in the case of implementation of a predictive model trained by REW-NPLS (corresponding to the prior art), and of implementation of the invention, taking into account a maximum weight per class equal to 2 and 10.

### DESCRIPTION OF PARTICULAR EMBODIMENTS

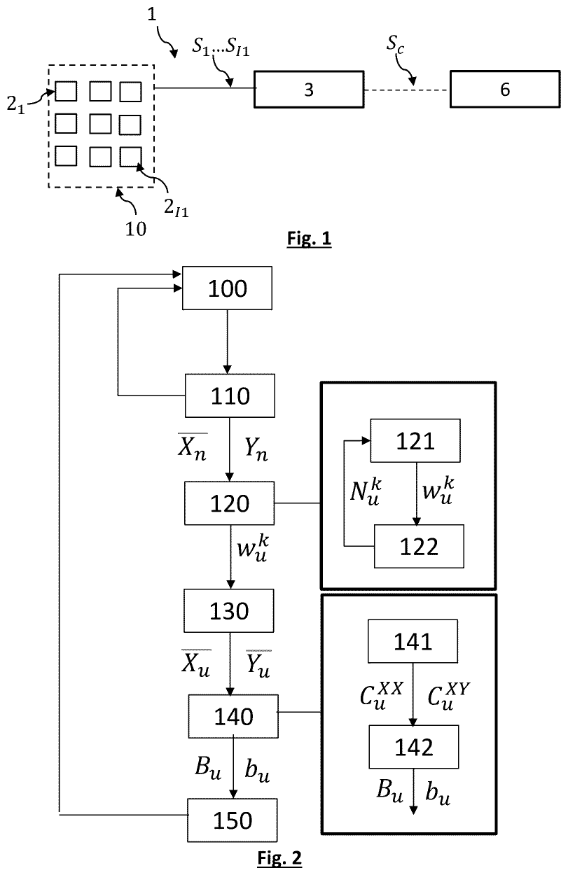

FIG. 1 shows the main elements of a brain-computer interface 1 according to the invention. It is a question of a device comprising sensors 2₁ . . . 2_{I1}, allowing electrophysiological signals representative of neural activity to be acquired. I1 is an integer corresponding to the number of sensors. The sensors 2₁ . . . 2_{I1} are for example cortical electrodes, the index E designating the number of cortical electrodes. The sensors 2₁ . . . 2_{I1} are connected to a processing unit 3, for example a microprocessor, by a wired or wireless link. Each sensor 2₁ . . . 2_{I1} is configured to detect an electrophysiological signal generated by a user 10. On the basis of each detected electrophysiological signal, each sensor 2₁ . . . 2_{I1} transmits an electronic signal S₁ . . . S_{I1} to the processing unit. The processing unit 3 is capable of implementing algorithms, of the predictive-model type, with a view to detecting features of the electronic signals S₁ . . . S_{I1} specific to a task performed by the user. The processing unit 3 may for example be a processor connected to a memory containing instructions allowing decoding algorithms to be implemented, i.e. decoding algorithms such as those described in the publications cited in connection with the prior art. Said decoding algorithms make it possible to decode the detected physiological signals, so as to determine features of the electrophysiological signals correlated with mental tasks performed by the user 10.

By mental task, designated task below, what is meant is an action imagined by a user to which the brain-computer interface is connected. It is a question of an action corresponding to an intention to perform a specific task, in particular a motor task. The user is instructed to perform the specific task by a third party or by a dedicated algorithm.

When the brain-computer interface 1 is operated, as mentioned in relation to the prior art, the user performs mental tasks in succession. The processing unit 3 receives the electronic signals S₁ . . . S_{I1} transmitted by the sensors 2₁ . . . 2_{I1}, which signals are representative of the electrophysiological signals produced by the user and detected by the sensors. On the basis of the detected electronic signals, when a correlation with a task is detected, the microprocessor generates a control signal Sc meant for an actuator 6. Thus, the brain-computer interface decodes the electrophysiological signals produced by the user 10 so as to generate, using a predictive model, control signals for controlling an actuator. The higher the quality of the training of the decoding algorithm, the higher the quality of the decoding.

During training, the user is provided with a list T of tasks Tₖ to perform. As described in connection with the prior art, during a training phase, a (human or machine) supervisor may ask the user to perform in succession tasks k chosen from the list of K tasks. The objective is to gradually determine the electrophysiological features best correlated with the tasks. These features then make it possible to establish the predictive model that is implemented during decoding, and via which the user 10 is able to control the actuator 6 connected to the processing unit 3.

Each task is to be performed during a time window, called an epoch, n. The number of epochs considered during training is very high, and may reach several hundred or several thousand. In EP3563218, which was cited in the discussion of the prior art, the principles of training by REW-NPLS are described. In such training, observation data in the form of a three-dimensional tensor are obtained in each epoch n.

The recorded electrophysiological signals are subjected to pre-processing, in which the signal of each electrode, during each epoch, undergoes frequency analysis. For example, it may be a question of a wavelet transform, a Morlet wavelet transform for example, or of a complex continuous wavelet transform (CCWT). The duration of each epoch n may be 1 second or 2 seconds, with a temporal overlap between two consecutive epochs. More precisely, during each epoch, a frequency analysis is carried out at regular intervals, every 100 ms for example. A plurality of temporally offset frequency analyses are thus carried out in each epoch. During an epoch, a plurality of frequency analyses are performed, the frequency analyses being temporally offset from one another.

With each epoch n there may be associated an observation tensor X̅ₙ̅:
the first mode of which corresponds to the position of each electrode, of dimension I1;
the second mode of which corresponds to the temporal positions of the wavelets, of dimension I2;
the third mode of which corresponds to the frequency bands resulting from the frequency analysis, of dimension I3.

A training sequence u comprises N epochs n, extending over a time range δt. u is an integer index assigned chronologically to each sequence. To each training sequence corresponds one training tensor X̅ᵤ̅, of N×I1×I2×I3 size: the training tensor X̅ᵤ̅ contains N normalized observation tensors X̅ₙ̅ as described below. More generally, the training tensor X̅ᵤ̅ is of N×I1 . . . ×Ih× . . . IH size, with 1≤h≤H, h being an index and H being a positive integer. In this example, H=3.

To each epoch n corresponds one control signal Yₙ, which may be represented by a control vector of (K,1) size. Each term of the control vector corresponds to one task Tₖ, from the list T of predefined tasks. During the N epochs forming the time range u, the various control signals form a matrix Yᵤ of (K,N) size.

Alternatively, the control signal Yₙ may be a matrix, or even a multidimensional tensor, in which case the various control signals form a tensor Y̅ᵤ̅ of mode N×J1 . . . ×Jg× . . . JG. G≥1. Generally, each task k corresponds to one specific control signal.

When the interface is implemented, the predictive model makes it possible to pass from the observation tensor X̅ₙ̅ to a control signal Yₙ for each epoch n.

The predictive model may in particular be a multilinear model, learnt by regression between X̅ᵤ̅ and Yᵤ, for example via an N-way partial least squares (NPLS) method. Such a model allows an estimation of the control signal according to an expression of the type: Ŷₙ=F(X̅ₙ̅) where F is the predictive model.

$${\hat{Y}}_{n} = B \overline{{X}_{n}} + b + ( 1 ) ,$$

where
B is a prediction tensor, containing prediction coefficients; and
b is a bias tensor.

The term tensor encompasses a vector (tensor of order 1), a matrix (tensor of order 2) and tensors of higher order.

In the example described below, non-limitingly, the predictive model is such that:

$${\hat{Y}}_{n} = B {X}_{n} + b , \qquad ( {1}^{′} )$$

where B is a matrix of (K,P) size, and Xₙ and b are vectors of (P, 1) and (K, 1) size. Xₙ is a vector resulting from vectorization of the tensor X̅ₙ̅, with

$$P = {\prod }_{h = 1}^{H} {I}_{h}$$

Expression (1) may be used to establish a generation probability. Taking into account the probabilities of changes of states, the user state, at various successive times, may be estimated using a hidden Markov model in which the task being performed by the user, at various successive times, is considered to be a state. By implementing an algorithm, for example the forward algorithm, it is possible to estimate the various successive states of the user.

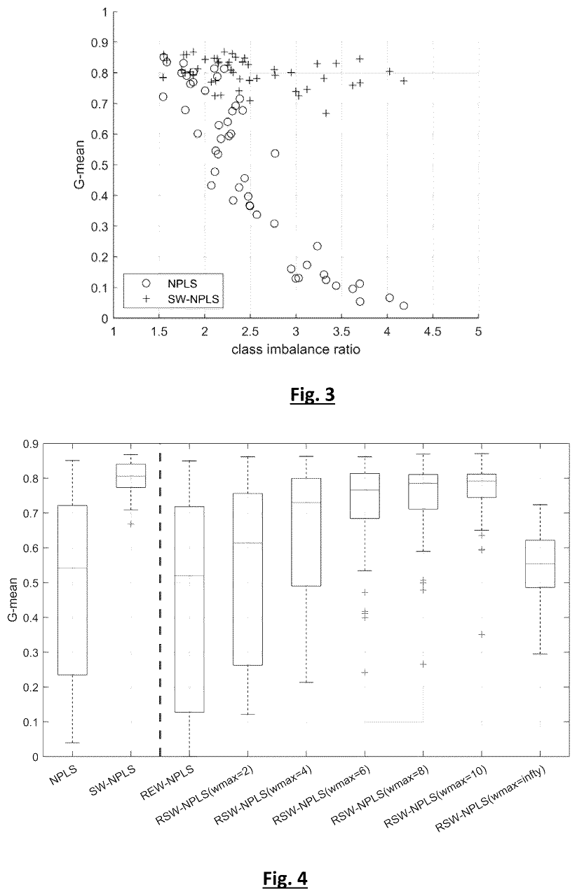

The main steps of a method allowing the invention to be implemented, so as to form a predictive model as described by (1) or (1′), will now be described with reference to FIG. 2. The predictive model is generated on-line, i.e. in real time or near real time, and updated iteratively, as described in EP3563218. Steps involving mathematical processing are implemented by the processing unit 3.

The objective of the predictive model is to estimate, during use of the interface, in an epoch n, the control vector Ŷₙ according to (1) or (1′).

It is known that the objective of a model established by NPLS is to project the observation tensor into a low-dimensional latent space maximizing the covariance between the observation and control tensors.

In EP3563218, tensors Xᵤ and Yᵤ and

$${C}_{u - 1}^{X X} and {C}_{u - 1}^{X Y}$$

determined in consecutive training sequences u and u−1 are used. Weighted covariance tensors are formed such that:

$${C}_{u}^{X X} = {X}_{u}^{T} {X}_{u} + λ {C}_{u - 1}^{X X} and \qquad ( 2 )$$

$${C}_{u}^{X Y} = {X}_{u}^{T} {Y}_{u} + λ {C}_{u - 1}^{X Y} \qquad ( 3 )$$

where λ is a forgetting factor. λ is a positive real number between 0 and 1.

This makes it possible to establish a predictive model, such as described in (1), by implementing a recursive REW-NPLS algorithm. The advantage thereof is that the predictive model is regularly updated, and that training requires only limited memory resources.

This makes it possible to form a predictive model such that Ŷₙ=Bᵤ X̅ₙ̅+bᵤ+Eₙ. Bᵤ and bᵤ are refreshed in each sequence.
Step 100: the user imagines a task k, at a time t, which corresponds to a known control signal Yₙ. The task associated with the time t may in particular correspond to a movement of the actuator, chosen from K possible tasks. At the same time, the electrophysiological signals resulting from the various sensors are recorded. More precisely, the electrophysiological signals are recorded during an epoch, n, extending over a duration δt from the time t.

Each term Yₙ(k) of the control signal corresponds to one task k. The value of Yₙ(k) is equal to 1 when the user imagines that they are executing the task k and 0 otherwise. One of the tasks may be a task requiring the user to remain in an inactive state (IS).
Step 110: Pre-processing. In each epoch n, the signals are subjected to a time-frequency analysis, as described above, so as to form an observation tensor X̅ₙ̅.

Steps 100 and 110 are repeated N times, so as to form a training tensor X̅ᵤ̅. N may for example be equal to 150. N is the number of epochs n forming the training sequence u. Below, u designates a sequence, i.e. a succession of times of epochs n. For example, the total duration of steps 100 to 110 may be 15 seconds, each epoch lasting a duration δt of 1 second, with an offset of 100 ms between two successive epochs n, n+1, this implying an overlap of 90% between two successive epochs.
Step 120: Assigning a weight to each epoch.

The inventors have observed that recursive training according to the prior art, as described in EP3563218, may lead to class imbalance. By class imbalance, what is meant is an imbalance in the occurrence of certain classes, corresponding to certain respective terms of the control vector. Specifically, certain tasks, corresponding to certain respective terms of the control vector, may be under-represented, and require a training period of longer duration. For example, when the actuator is an exoskeleton, a command to translate the hand may require more training than a command to rotate the wrist.

Furthermore, the imbalance affecting how difficult it is to learn tasks may vary over time, between various successive training sequences.

In addition, during training, an additional task may be added, leading to addition of a term to the control vector.

During training, the user, or supervisor, cannot, by themselves, compensate for the imbalance between tasks, because the fact that learning certain tasks k is more difficult than learning others cannot be controlled by the user.

Thus, to each epoch n a weight wₙ is assigned, the value of which weight varies depending on whether it is desired to over- or under-represent the observation in said epoch n. More precisely, the weight wₙ depends on the task k assigned to epoch n, among the K possible tasks. Task k assigned to epoch n corresponds to the non-zero term of the control signal Yₙ. During a given sequence u, the weights wₙ corresponding to a given task k, i.e. to the same task, have the same value. Thus, for a given task k, the assigned weight, during a given sequence u, is

$${w}_{u}^{k} .$$

### Sub-Step 121: Determining the Weights wₙ

Following a sequence u, the weights forming the matrix diag(Wᵤ) are established as follows:
The number of occurrences

$${N}_{u}^{maj}$$

of the majority class is determined after sequence u:

$${N}_{u}^{maj} = {max}_{k} ( λ {N}_{u - 1}^{k} + {n}_{u}^{k} ) , \qquad ( 4 )$$

where:

$${N}_{u - 1}^{k}$$

is the number of occurrences of each class k after the previous sequence u−1. During the first sequence,

$${N}_{u - 1}^{k}$$

is initialized, and for example set equal to 0;

$${n}_{u}^{k}$$

is the number of occurrences of each class k in sequence u, before weighting;
λ is the forgetting factor described above.
The weight

$${w}_{u}^{k}$$

assigned to each class k is determined during the sequence by:

$${w}_{u}^{k} = \frac{{N}_{u}^{maj} - λ {N}_{u - 1}^{k}}{{n}_{u}^{k}} and \qquad ( 5 )$$

$${w}_{u}^{k} = 0 if {n}_{u}^{k} = 0 \qquad ( 6 )$$

It is preferable for excessive weights not to be assigned to certain tasks, so as not to increase the noise level affecting the definition of the predictive model. This is equivalent to avoiding overweighting certain classes k. Thus, it is possible to set a maximum value wₘₐₓ. When (5) leads to a value

$${w}_{u}^{k}$$

such that

$${w}_{u}^{k} \geq {w}_{m ax} , then {w}_{u}^{k} = {w}_{m ax} .$$

After the weight

$${w}_{u}^{k}$$

assigned to each class k has been defined, the weight wₙ associated with the epoch n is such that

$${w}_{n} = {w}_{u}^{k} ,$$

k corresponding to the task associated with the epoch n.

### Sub-step 122: Determining

$${N}_{u}^{k}$$

$${N}_{u}^{k} ,$$

which corresponds to the weighted number of occurrences of class k, is determined via:

$${N}_{u}^{k} = λ {N}_{u - 1}^{k} + {w}_{u}^{k} {n}_{u}^{k} \qquad ( 7 )$$

$${N}_{u}^{k}$$

is intended to be used in the implementation of expressions (5) and (6) in the following sequence u+1.

In addition to the frequency of occurrence of the tasks, other criteria may be taken into account to assign a weight to each epoch n:
training performance—for example, tasks the training performance of which is considered low may be underweighted. Training quality may be assessed via a performance indicator of recall type, corresponding to a ratio between the number of occurrences of correctly classified tasks and the number of tasks imagined by the user;
the presence of an outlier in the epoch in question, in which case the weight may be set to zero—it is a question here of assigning a weight depending on the quality of the recorded signals, so as to minimize or negate the influence of signals considered to be outliers;
a change in task, times occurring just after a change in task being underweighted with respect to times after the change—this allows a reaction time of the user, after each change in task, to be taken into account, the neurological response of the user being considered to be transient during said time.

More generally, a weighting criterion is defined for each epoch. It may be a question of a frequency-of-occurrence criterion quantifying the frequency of occurrence of the task performed in each epoch, or of a training-performance criterion quantifying the training performance of the task selected in each epoch, or of a signal-quality criterion quantifying the quality of the signals recorded in each epoch, or of a time criterion quantifying an amount of time following a change in task.

The weighting criteria may be combined: for example, the weight of an epoch may be defined based on both frequency of occurrence and training performance.

In order for the invention to make sense, it is preferable for at least two different epochs of a given sequence to be assigned two different respective weights.
Step 130: Forming the training tensor and the control vector for sequence u.

To each training sequence u corresponds one training tensor X̅ᵤ̅, of N×I1×I2×I3 size: the training tensor X̅ᵤ̅ contains N observation tensors X̅ₙ̅ corresponding to N respective epochs n. Each observation tensor X̅ₙ̅ is formed from terms (x_{n,i}_{₁}, . . . i_{H}), where H is the number of modes of the observation tensor.

The formation of the training tensor comprises normalizing the observation tensors X̅ₙ̅, then grouping each normalized observation tensor formed for each epoch n of the same sequence u.

Each observation tensor X̅ₙ̅ is normalized via the following operations:

$${N}_{u}^{Tot} = λ {N}_{u - 1}^{Tot} + {\sum }_{n = 1}^{W} {w}_{n} \qquad ( 8 )$$

$${N}_{u}^{Tot}$$

is a normalization term for sequence u;

$${N}_{u}^{Tot}$$

is the size of the database of training data accumulated since the beginning of the training taking the weights into account;
λ is the forgetting factor described above;
wₙ is the weight associated with each epoch n in sequence u;

$${N}_{u - 1}^{Tot}$$

is the normalization term for the previous sequence u−1. In the first sequence (u=1),

$${N}_{0}^{Tot} = 0 .$$

An average

$${μ}_{u}^{Xi}$$

is then calculated for each term of the N observation tensors, forming the sequence u

$${μ}_{u}^{Xi} = \frac{1}{{N}_{u}^{Tot}} ( λ {N}_{u - 1}^{Tot} {μ}_{u - 1}^{Xi} + {\sum }_{n = 1}^{N} {w}_{n} {x}_{n , i} ) \qquad ( 9 )$$

where i=(i₁ . . . i_{H})
and x_{n,i} is each term of coordinate i of the observation tensor X̅ₙ̅.

A sum of squares is then calculated

$${SS}_{u}^{Xi} : {SS}_{u}^{Xi} = ( λ S {S}_{u - 1}^{Xi} + {\sum }_{n = 1}^{N} {w}_{n} {x}_{n , i}^{2} ) \qquad ( 10 )$$

A standard deviation is then calculated:

$${σ}_{u}^{Xi} = \sqrt{\frac{S {S}_{u}^{Xi} - {N}_{u}^{Tot} {μ}_{u}^{{i}^{2}}}{{N}_{u}^{Tot} - 1}} . \qquad ( 11 )$$

Next, each term of the observation tensor X̅ₙ̅ is normalized by:

$${x}_{n , i} ← \frac{{x}_{n , i} - {μ}_{u}^{Xi}}{{σ}_{u}^{i}} , \qquad ( 12 )$$

←meaning “is replaced by”.

The same procedure is followed for each control vector Yₙ. An average

$${μ}_{u}^{Yk}$$

is calculated for each term of the N control vectors Yₙ of sequence u:

$${μ}_{u}^{Yk} = \frac{1}{{N}_{u}^{Tot}} ( λ {N}_{u - 1}^{Tot} {μ}_{u - 1}^{Yk} + {\sum }_{n = 1}^{N} {w}_{n} {y}_{n , k} ) \qquad ( 13 )$$

y_{n,k} being a term of coordinate k of control vector Yₙ.

A sum of squares is then calculated

$${SS}_{u}^{Yk} : {SS}_{u}^{Yk} = ( λ {SS}_{u - 1}^{Yk} + {\sum }_{n = 1}^{N} {w}_{n} {y}_{n , k}^{2} ) \qquad ( 14 )$$

A standard deviation is then calculated:

$${σ}_{u}^{Yk} = \sqrt{\frac{{SS}_{u}^{Yk} - {N}_{u}^{Tot} {μ}_{u}^{{Yk}^{2}}}{{N}_{u}^{Tot} - 1}} \qquad ( 15 )$$

Next, each term of the control tensor is normalized by:

$${y}_{n , k} ← \frac{{y}_{n , k} - {μ}_{u}^{Yk}}{{σ}_{u}^{Yk}} \qquad ( 16 )$$

Step 130 amounts to normalizing each observation tensor X̅ₙ̅ and each control tensor Yₙ while taking into account the weight wₙ associated with each epoch n of sequence u. The aim is to calculate a sliding average and a sliding standard deviation, weighted by the weight assigned to each epoch, of each term of the observation tensors and of the control vector. The sliding average and the sliding standard deviation are calculated for terms of same coordinates, taking into account each epoch n forming the sequence u.

The training tensor X̅ᵤ̅ and the control matrix Yᵤ are then formed for sequence u. Each normalized observation tensor X̅ₙ̅ may be expressed in the form of an observation vector Xₙ, of size P, with P=I1×I2×I3, following vectorization of the tensor X̅ₙ̅, in which case the training tensor X̅ᵤ̅ is a training matrix Xᵤ formed from N observation vectors: Xᵤ=(Xₙ₌₁, . . . X_{n=N})^{T}. The training matrix Xᵤ is of (N, P) size.

A control matrix Yᵤ is also formed from each normalized control vector. Yᵤ=(Yₙ₌₁, . . . Y_{n=N})^{T}. In this example, Yᵤ is of (N, K) size.
Step 140: Establishing the predictive model.

The way in which a predictive model is established from the training matrix Xᵤ and the control matrix Yᵤ resulting from step 130 will now be described. First the predictive model described in (1) and (1′) must be established.
Sub-step 141

From the training matrix Xᵤ and the control matrix Yᵤ, the covariance and cross-covariance matrices are derived, as follows:

$${C}_{u}^{XX} = {X}_{u}^{T} diag ( {W}_{u} ) {X}_{u} + λ {C}_{u - 1}^{XX} \qquad ( 20 )$$

$$and$$

$${C}_{u}^{XY} = {X}_{u}^{T} diag ( {W}_{u} ) {Y}_{u} + λ {C}_{u - 1}^{XY} \qquad ( 21 )$$

diag(Wᵤ) being a diagonal matrix of (N,N) size. Each term of diag(Wᵤ) is the weight wₙ assigned to the epoch n, as calculated in step 120.
Sub-step 142: during this sub-step, the matrix Bᵤ and the vector bᵤ are determined from the covariance and cross-covariance matrices

$${C}_{u}^{XX}$$

$$and$$

$${C}_{u}^{XY}$$

resulting from the preceding sub-step, as described in EP3563218. This in particular corresponds to step 140 of EP3563218. In EP3563218, the predictive control model is updated via N-way partial least squares (NPLS) regression, but other types of multivariate regression can be used.

The predictive model may be used to estimate the most probable task that the user would like to perform, via an algorithm based on a hidden Markov model (HMM), each task being considered to be one user state. In this case, one user state is assigned to each epoch, the user state corresponding to execution of a task. The successive states are estimated by an algorithm based on a hidden Markov model, using the predictive model, as described in EP3789852.
Step 150: Reiterating. Steps 100 to 140 are reiterated for a following sequence, this allowing the predictive model to be regularly, or even continuously, updated.

### Experimental Trials

The method described above was implemented, based on data collected during the clinical trial “Brain Computer Interface: Neuroprosthetic Control of a Motorized Exoskeleton”, reported on clinicaltrials.gov under reference NCT02550522. These sequences are described in A. L. Benabid et al., “An exoskeleton controlled by an epidural wireless brain-machine interface in a tetraplegic patient: a proof-of-concept demonstration”, The Lancet Neurology, Vol. 18, no. 12, Art. no. 12, December 2019, and in A. Moly et al., “An adaptive closed-loop ECoG decoder for long-term and stable bimanual control of an exoskeleton by a tetraplegic”, J. Neural Eng., vol. 19, no. 2, Art. no. 2, March 2022.

ECoG signals were recorded using a wireless WIMAGINE implant as described in Mestais C. et al “WIMAGINE: Wireless 64-channel ECoG recording implant for long term clinical applications”, IEEE Transactions on Neural Systems and Rehabilitation Engineering, Vol. 23, No. 1, January 2015.

An observation tensor was calculated every 100 ms, in a moving window. The frequency analysis was performed by applying a complex continuous wavelet transform (CCWT) to the latest second of signal, with fifteen wavelets derived from the Morlet mother wavelet, the derived wavelets being centred on fifteen equally spaced frequencies between 10 and 150 Hz.

Each sequence was contained in a buffer storing the data delivered by each sensor for 15 seconds. This corresponded to a set of 150 observation data per buffer. The duration of an epoch was 1 second.

During the training process, the user was instructed to perform mental tasks that were intended to control a virtual avatar. The predictive model was trained to decode five different tasks:
translation of the right hand (AS RH);
translation of the left hand (AS LH);
rotation of the right wrist (AS RW);
rotation of the left wrist (AS LW);
inactive state (IS).

In each epoch, i.e. every 100 ms, a control vector Yₜ was formed, the control vector containing 5 terms Yₜ (k), the term of the task k being executed set equal to 1, k being between 1 and 5.

There were 10 sequences, from which 5 sequences were randomly chosen to be used to train the predictive model and 5 sequences were randomly chosen to be used for tests, during which the predictive model was applied. This was repeated 50 times, while ensuring that the sets of test sequences and training sequences were not the same.

The respective durations of the sequences were 37 min 26 s, 29 min 8 s, 48 min 3 s, 9 min 35 s, 50 min 6 s, 53 min 2 s, 31 min 41 s, 37 min 58 s, 47 min 34 s, and 22 min 12 s, respectively.

During the tests, each model was evaluated by means of a performance criterion corresponding to a geometric mean of the recall, denoted Gm. The recall of a class k was defined by P(Ŷₜ=k|Yₜ=k). The geometric mean was defined as:

$$Gm = {\prod }_{k = 1}^{K} {P ( {\hat{Y}}_{t} = k \vert {Y}_{t} = k )}^{1 / K} \qquad ( 22 )$$

Gm was equal to 1 if all data were correctly classified. The recalls calculated for each class, and the geometric mean Gm, were independent of the size of each class.

For each predictive model, a class imbalance ratio CIR such that

$$CIR = \frac{size of the majority class}{size of the minority class} \qquad ( 23 )$$

was quantified.

The greater the class imbalance, the higher the CIR ratio. A CIR equal to 1 corresponded to a perfect balance between each class.

In the trials, Ŷₙ was estimated by applying the predictive model to the data corresponding to each epoch, and Yₙ was the control vector corresponding to the requested task.

Various values of wₘₐₓ between 2 and infinity were employed. When wₘₐₓ was equal to infinity, it meant that there was no maximum value assigned to the weights.

Off-line training was also performed without taking into account the forgetting factor in the covariance and cross-covariance matrices. This amounted to defining the predictive model:
either by NPLS;
or by implementing the invention, without taking into account the forgetting factor (λ=0)—i.e. weighted NPLS, or sample-weighted NPLS (SW-NPLS)—in which case the tensors taken into account, in each sequence, were:

$${C}_{u}^{XX} = {X}_{u}^{T} diag ( W ) {X}_{u} \qquad ( 24 )$$

$$and$$

$${C}_{u}^{XY} = {X}_{u}^{T} diag ( W ) {Y}_{u} . \qquad ( {24}^{′} )$$

In this case, the matrix of weights diag(W) was a diagonal matrix of (N,N) size, each term of which was associated with one epoch n, and the value of which was the weight assigned to the class k corresponding to the epoch n.
Each class was assigned a weight

$${w}_{u}^{k} ,$$

the value of which was

$${w}_{u}^{k} = \frac{{N}_{u}^{maj}}{{n}_{u}^{k}} . \qquad ( 25 )$$

$${N}_{u}^{maj}$$

corresponded to the value of the majority class and

$${n}_{u}^{k}$$

corresponded to the value of class k.

The off-line training was carried out in multiple training sessions, the total time spent training being between 130 min and 240 min. As indicated above, off-line training is not easy to reconcile with integration into a compact device, because it requires a large amount of memory given the number of data processed. It was used here for the purposes of comparison with the on-line training carried out.

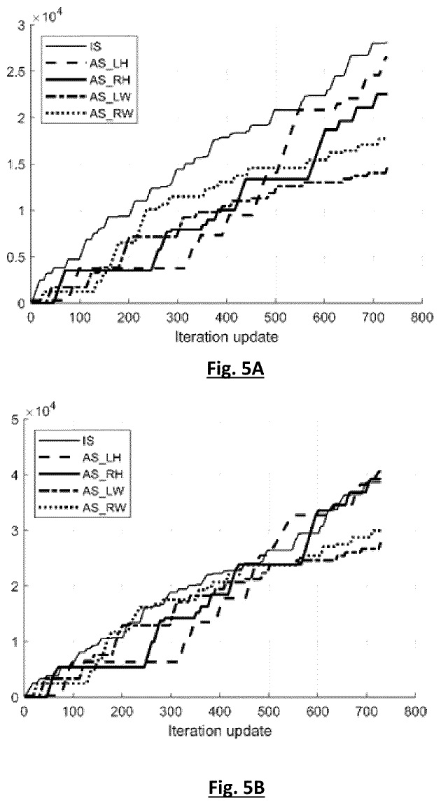

FIG. 3 shows the geometric mean Gm, as defined in (9), calculated using the respective predictive models established off-line by NPLS or SW-NPLS. The geometric mean is shown as a function of the CIR. Each point in this figure corresponds to one test of a predictive model obtained by NPLS or SW-NPLS using training data corresponding to 5 sequences randomly selected from the first 10 sequences of the database. The predictive model was tested using the other 5 sequences, i.e. the 5 sequences not selected to be used for training from the first 10 sequences. The experiments (training and test) were repeated 50 times. It may be seen that in case of a large imbalance (high imbalance ratio), the geometric mean of the recalls Gm of the SW-NPLS algorithm far exceeds the geometric mean obtained by NPLS. This shows that in case of imbalance between classes, the predictive model obtained by SW-NPLS is more accurate than the predictive model obtained by NPLS. This comparison confirms the advantageousness of weighting under-represented classes.

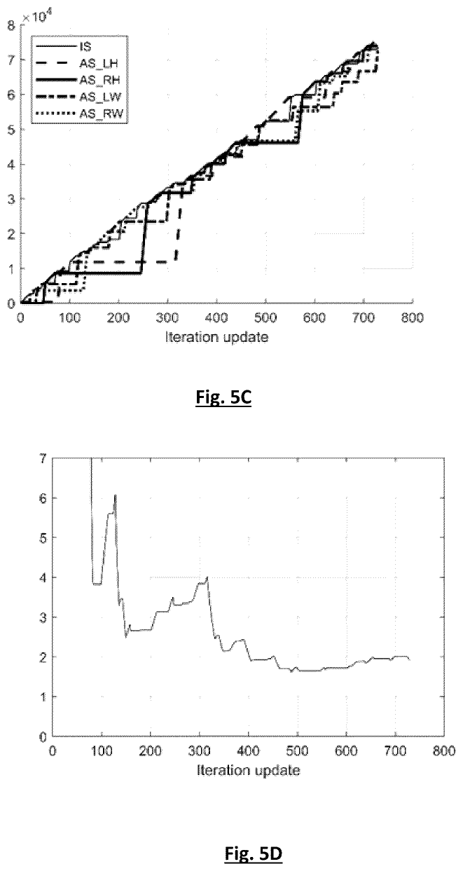

FIG. 4 shows a comparison of the geometric mean of the class recall determined by various algorithms. It is a question of a boxplot. The results are depicted by a box the ends of which represent the first and third quartiles (the centre line corresponding to the median). The extreme values, outside the box, show the minimum and maximum values. The x-axis corresponds to each algorithm implemented, with, from left to right:
NPLS (off-line);
SW-NPLS (off-line);
REW-NPLS (on-line); and
the invention (RSW-NPLS—on-line recursive model, with weighting of each sample) with a maximum value wₘₐₓ set equal to 2, 4, 6, 8, 10 and infinity, respectively. Setting wₘₐₓ equal to infinity amounts to not using a maximum value.

In FIG. 4, a vertical dashed line has been drawn, separating off-line and on-line training.

It may be seen that the maximum value of Gm was obtained using a predictive model generated off-line by SW-NPLS. However, as indicated above, it was a question of a model that was trained off-line. It may be considered an optimum to which to aspire.

The performance of recursive models trained on-line was better when the classes were weighted (RSW-NPLS models). It may also be seen that the value of wₘₐₓ had an influence on classification performance. When wₘₐₓ=8 or wₘₐₓ=10, the classification performance was similar to the classification performance obtained with the model established off-line by SW-NPLS (non-recursive approach).

When a wₘₐₓ was not taken into account, i.e. when wₘₐₓ was set equal to infinity, the classification performance was worse than when a wₘₐₓ was taken into account.

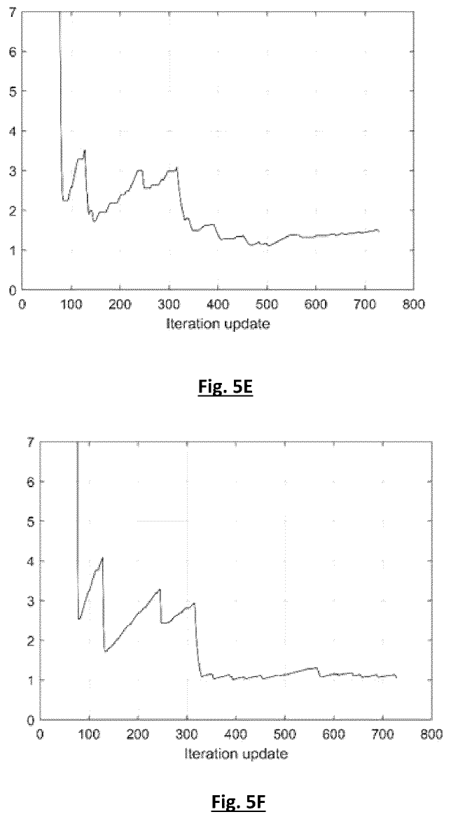

FIGS. 5A to 5C show a variation in class size as a function of a number of iterations in the case of implementation of a predictive model trained by REW-NPLS (recursive NPLS approach without epoch weighting, corresponding to the prior art), and of implementation of the invention, taking into account a maximum weight per class equal to 2 and 10, respectively. Without weighting (with REW-NPLS), the IS class was over-represented by a factor of 2. The RSW-NPLS algorithms improved the class balance. When wₘₐₓ=2, only two tasks (SS_{LH} and AS_{RH}) were balanced with the IS class. When wₘₐₓ=10, the constraint imposed by the algorithm is strict enough that all the classes are balanced after a sufficient number of iterations.

FIGS. 5D to 5F show the class imbalance ratio as a function of a number of iterations in the case of implementation of a predictive model trained by REW-NPLS (corresponding to the prior art), and of implementation of the invention (RSW-NPLS), taking into account a maximum weight per class equal to 2 and 10. It may be seen that weighting reduces the class imbalance ratio, as explained in (8), particularly when

$${w}_{max} = 10.$$

In FIGS. 5A to 5F, each curve corresponds to one task among the tasks listed beforehand.

### Variants

According to one possibility, it is advantageous, during training, to deliberately aim for a specific imbalance between the tasks performed by the user. This may in particular concern one predetermined task, resting for example. Insufficient training of the resting state may result in generation, during implementation of the predictive model, of false activations, whereby the user is considered to be in an active state when the desired state is a resting state.

For example, a higher proportion of occurrences may be targeted for resting than for the other, active, tasks. For this purpose, to each task k, a target proportion Rₖ is assigned.

In sub-step 121, the target proportion Rₖ is taken into account as follows:

$${N}_{u}^{maj} = {max}_{k} ( \frac{λ {N}_{u - 1}^{k} + {n}_{u}^{k}}{{R}_{k \cdot }} ) \qquad ( {4}^{′} )$$

$$and$$

$${w}_{u}^{k} = \frac{{N}_{u}^{maj} {R}_{k} - λ {N}_{u - 1}^{k}}{{n}_{u}^{k}} \qquad ( {5}^{′} )$$

The inventors believe that it is preferable for the task of resting to be over-represented by a factor of 2 to 2.5 compared to the other, active, tasks. This improves the performance and stability of implementation of the predictive model.

In the description of the sub-step 121, respective weights w_{u,k} corresponding to each class were calculated in order to achieve a balance between the various classes, i.e. to increase the weight of classes in proportion to the extent that they are in the minority. According to another possibility, the weight of classes that are in the majority may be decreased.

The invention allows a predictive model to be trained on-line, and may be implemented by any BCI system, including in devices in which the decoded intention is transmitted to the nerves of the spinal column or to the muscles. In this case, the actuator is implanted in the user's body beforehand: it may be a stimulating device, for example.

1. A Method for training a brain-computer interface, the brain-computer interface being connected to sensors arranged around the brain of a user, each sensor being configured to detect an electrophysiological signal dependent on a neural activity of the user, the interface being configured to control an actuator based on the detected electrophysiological signals, the method comprising:
a) selecting a mental task to be performed, chosen from a predetermined list of tasks;
b) the user executing the mental task selected in step a), the training method further comprising, during execution of the task:
acquiring electronic signals generated by the various sensors;
extracting features from the electronic signals;
forming an observation tensor from the features extracted from the signals;
c) repeating steps a) and b) during a predetermined number of time epochs, forming a sequence;
d) forming a training tensor from the observation tensors formed in each time epoch, and a control tensor from the tasks selected in each epoch, each term of the training tensor and of the control tensor being associated with one epoch of the sequence;
e) forming a predictive model, by regression between the training tensor and the control tensor, the predictive model being configured to predict a task, chosen from the list of tasks, imagined by the user depending on the observation tensor formed in each epoch;
wherein steps b), d) and e) are implemented by a processing unit;
wherein the method further comprises:
defining a weighting criterion for each epoch;
assigning a weight to each epoch, the weight being defined depending on the weighting criterion of said epoch, so that to two different epochs, of the sequence, of which the weighting criterion is different, two different weights are assigned;
wherein the predictive model is formed depending on the weight assigned to each epoch.

2. The method according to claim 1, wherein the weight assigned to an epoch depends on the task selected during said epoch.

3. The method according to claim 2, wherein:
steps a) to e) are implemented during a plurality of successive sequences;
the weighting criterion is a frequency of occurrence of each task, the weight of each epoch increasing as the number of occurrences of the task, in the successive performed sequences, decreases.

4. The method according to claim 3 comprising, after each new sequence, updating a weighted total number of occurrences for each task, wherein updating comprises, for each task:
determining a number of occurrences of the task in the new sequence;
weighting the number of occurrences of the task, in the new sequence, by the weight assigned to said task in the new sequence;
summing the weighted number of occurrences of the task, in the new sequence, to the weighted total number for said task resulting from the previous sequence, the latter being multiplied by a forgetting factor.

5. The method according to claim 1, wherein the weighting criterion is a training-performance criterion, the method comprising:
determining a training-performance indicator for each task following each epoch;
determining the weight of each task based on the training-performance criterion of the task.

6. The method according to claim 1, wherein the weighting criterion is a signal-quality criterion quantifying the quality of the signals collected in each sequence, the method comprising:
determining a signal-quality criterion for the signals collected in each sequence;
determining the weight of each task depending on the signal-quality criterion of the respective signals collected during the execution of each task.

7. The method according to claim 1, wherein, in step e), the predictive model is formed by N-way regression, comprising calculation of a cross-covariance tensor expressing the cross-covariance between the training tensor and the control tensor, the cross-covariance tensor of each sequence being established from a product:
of the observation tensor;
of the control tensor;
and of the respective weights assigned to each epoch.

8. The method according to claim 7, wherein
step c) is repeated so as to form a plurality of successive sequences, each sequence being assigned a rank;
step d) is implemented for each sequence;
in step e), the predictive model is formed from two successive sequences, comprising a sequence of low rank and a sequence of high rank, on the basis of a sum of the cross-covariance tensor established for the sequence of high rank and of the cross-covariance tensor established for the sequence of low rank multiplied by a forgetting factor (λ).

9. The method according claim 8, wherein:
the training tensor and the control tensor each form a matrix, wherein one dimension of each matrix is the number of epochs in the sequence;
the weights form a diagonal matrix, each dimension of which is the number of epochs per sequence, each term of the diagonal matrix corresponding to the weight assigned to each epoch executed in said sequence.

10. The method according to claim 1, wherein, for at least one specific task, the weight is determined such that the number of occurrences of said specific task, weighted by the weight assigned to the specific task, is greater than the number of occurrences of at least one other task, weighted by the weight assigned to said other task.

11. The method according to claim 1, wherein the weight assigned to each task is bounded by a predefined maximum value.

12. A brain-computer interface, comprising sensors arranged around the brain of a user, and configured to detect electrophysiological signals representative of neural activity of the user, the interface being configured to control an actuator, by implementing a predictive model, the predictive model being configured to generate an actuator control signal from detected electrophysiological signals;
the interface comprising a processing unit (3), configured to acquire the electronic signals in each step b), and to implement steps d) and e) of a method according to claim 1.

13. The brain-computer interface according to claim 12, wherein the actuator is a device external to the user or a device implanted in the user's body.
